(19) United States
(12) Patent Application Publication
(10) Pub. No.: US 2012/0050667 A1
(43) Pub. Date: Mar. 1, 2012

(54) Eyeglasses Capable of Being Recharged and Providing Three-Stage Lighting

(76) Inventor: Ching-Hsiang Wang, Tainan City (TW)

(21) Appl. No.: 12/870,885

(22) Filed: Aug. 30, 2010

(51) Int. Cl. G02C 11/04

(52) U.S. Cl. 351/158

(57) ABSTRACT

Eyeglasses capable of being recharged and providing three-stage lighting are disclosed, wherein the front end of each of two temples of the eyeglasses has an outer side connected with a lighting device. Each lighting device includes a housing that houses a circuit board, a battery, and so on, wherein the circuit board is connected with a switch button and a light-emitting body. Each temple has a downward-facing charging hole adjacent to the corresponding battery. The circuit board of each lighting device is configured in such a way that, by pressing the corresponding switch button, the corresponding light-emitting body is switched between a constant lighting mode, an intermittent flashing mode, and an OFF mode, thus providing the desired lighting or warning via the three-stage control. In addition, the batteries in the lighting devices can be charged via the charging holes at the bottom sides of the temples.

### BACKGROUND OF THE INVENTION

1. Technical Field

The present invention relates to eyeglasses and, more particularly, to eyeglasses capable of being recharged and providing three-stage lighting, wherein each of the bilaterally disposed temples of the eyeglasses is provided with a lighting device that can control a light-emitting body to emit light constantly or flash intermittently, thereby producing the desired lighting or warning effect.

2. Description of Related Art

Nowadays, there are a great variety of eyeglass assemblies for consumers to choose from based on practical needs. For example, some eyeglasses have temples connected by a strap for adjusting the fit of the eyeglasses elastically, thus allowing the eyeglasses to be worn during sports activities without falling off. Some eyeglasses have a pair of auxiliary eyeglasses pivotally provided at the front side of the lens-bearing frame so as to shade the sun or provide vision correction. There are also eyeglasses with lighting devices provided on the lens-bearing frame so as to provide auxiliary lighting when needed, such as at night, or when the background lighting is so dim that clear vision is prevented, or when additional lighting is needed at work. However, such light-emitting eyeglasses have the following drawbacks:

1. If the lighting devices are used on a regular basis, the batteries run out fast and need to be replaced frequently, which is environmentally unfriendly.

2. As the lighting devices are provided on the lens-bearing frame, the light emitted by the lighting devices tends to project directly into and thereby irritate the wearer's eyes.

### BRIEF SUMMARY OF THE INVENTION

Therefore, in view of the drawbacks of the existing lighting devices for use with eyeglasses, the inventor of the present invention incorporated years of manufacturing and designing experience, as well as knowledge in the related field, into improvement of the prior art devices while trying to maintain their original lighting effects. Finally, eyeglasses with high added value as disclosed herein were successfully developed which not only can provide lighting at night or in particular places, but also can provide warning signals to enhance safety (e.g., to alert drivers on the street to the wearer of the eyeglasses on a dark rainy day or at night, thereby preventing car accidents).

The primary object of the present invention is to provide eyeglasses capable of being recharged and providing three-stage lighting, wherein the front end of each of two temples of the eyeglasses has an outer side provided with a lighting device. Each lighting device includes a housing that houses a circuit board, a battery, and so on, wherein the circuit board is connected with a switch button and a light-emitting body. In addition, each temple has a charging hole located adjacent to the corresponding battery and facing downward. The circuit board of each lighting device is configured in such a way that the corresponding light-emitting body is switchable between a constant lighting mode, an intermittent flashing mode, and an OFF mode by pressing the corresponding switch button. Thus, the desired lighting or warning effect can be achieved via the three-stage control. Furthermore, the batteries in the lighting devices can be charged through the charging holes at the bottom sides of the temples.

The second object of the present invention is to provide the foregoing eyeglasses, wherein a connector is pivotally connected to the front end of each temple by a threaded fastener. Each connector has a resilient portion for engaging with an engaging hole of a lens-bearing frame of the eyeglasses and thereby providing rapid and stable positioning. The resilient portions of the connectors also facilitate installation, removal, and replacement of the temples.

### BRIEF DESCRIPTION OF THE SEVERAL VIEWS OF THE DRAWINGS

The invention as well as a preferred mode of use, further objects, and advantages thereof will be best understood by referring to the following detailed description of an illustrative embodiment in conjunction with the accompanying drawings, in which:

FIG. 1 is a perspective view of a pair of light-emitting eyeglasses according to the present invention;

FIG. 2 is a partial exploded perspective view of the eyeglasses shown in FIG. 1; and

FIG. 3 is a partial bottom perspective view of the eyeglasses shown in FIG. 1.

### DETAILED DESCRIPTION OF THE INVENTION

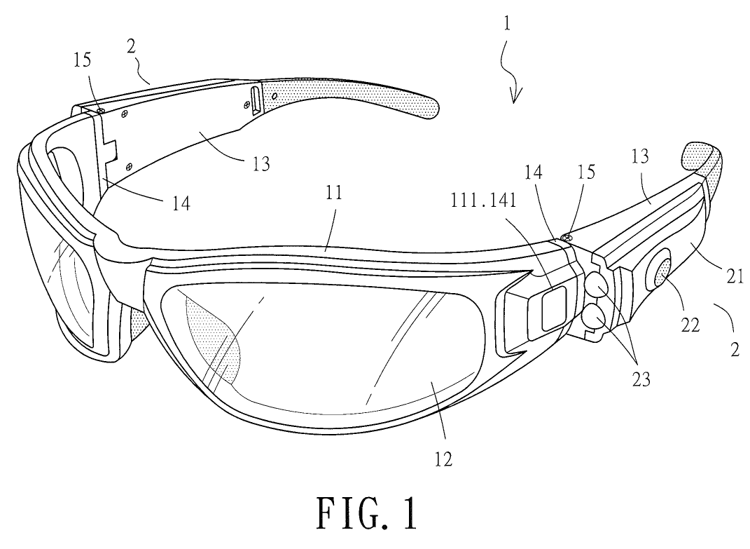

Referring to FIG. 1, the present invention provides eyeglasses 1 capable of being recharged and providing three-stage lighting, wherein the eyeglasses 1 are connected with lighting devices 2.

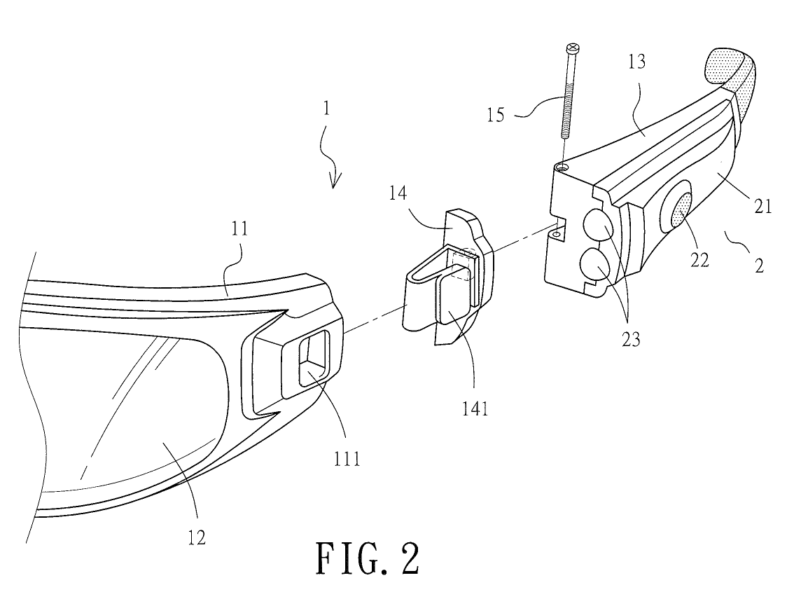

The eyeglasses 1 are composed of a frame 11, lenses 12, temples 13, and connectors 14. As shown in FIG. 2, the temple 13 is pivotally connected to the connector 14 by a threaded fastener 15. Then, a resilient portion 141 integrally formed with the connector 14 is engaged with an engaging hole 111 of the frame 11 to provide rapid and stable positioning.

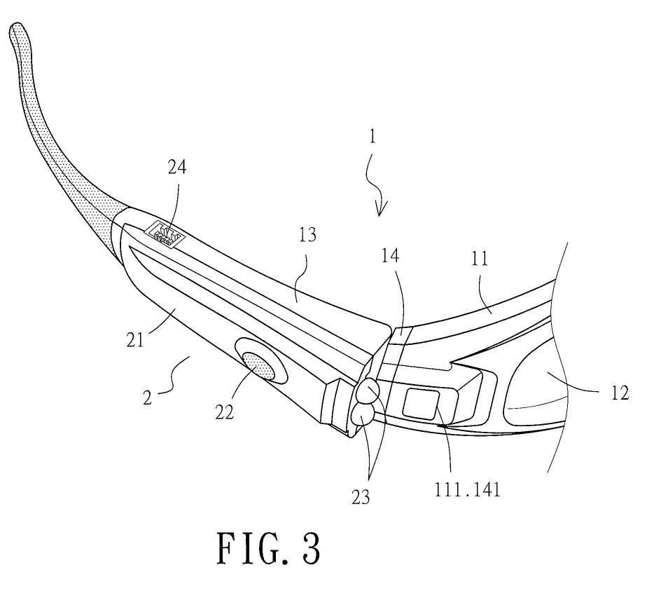

The front end of each of the two temples 13 has an outer side coupled with a lighting device 2. As shown in FIG. 2, the lighting device 2 includes a housing 21 that houses a circuit board, a battery, and so on. The circuit board is connected with a switch button 22 and light-emitting bodies 23. (In this embodiment, the light-emitting bodies 23 are LEDs.) In addition, referring to FIG. 3, a charging hole 24 having a downward opening is formed on the temple 13 at a position adjacent to the battery.

The circuit boards of the lighting devices 2 are configured in such a way that, by pressing the switch buttons 22, the light-emitting bodies 23 are switched between a constant lighting mode, an intermittent flashing mode, and an OFF mode. Thus, the desired lighting or warning effect is provided via the three-stage control. Besides, the batteries in the lighting devices 2 can be charged via the charging holes 24 at the bottom sides of the temples 13. Furthermore, by virtue of the resilient portions 141 of the connectors 14, the temples 13 can be installed to or removed from the frame 11 rapidly, or be easily replaced by temples 13 of other configurations.

The eyeglasses capable of being recharged and providing three-stage lighting as disclosed herein have the following advantages in use:

1. As the charging holes allow charging of the batteries in the lighting devices, the batteries need not be changed, and therefore pollution related to battery disposal is prevented.

2. With the light-emitting bodies of the lighting devices being provided at the front ends of the bilaterally disposed temples, the light emitted by the light-emitting bodies will not enter the wearer's eyes directly.

3. The three-stage control provided by the circuit boards of the lighting devices allows the light-emitting bodies to be switched to any of the constant lighting mode, the intermittent flashing mode, and the OFF mode by pressing the switch buttons.

4. The eyeglasses provide the lighting effect required at night or in particular places.

5. The eyeglasses provides safety alert. For instance, while the wearer of the eyeglasses is walking on the street on a gloomy rainy day or at night, the light emitted by the lighting devices can serve as a warning to drivers on the street to prevent traffic accidents.

6. As the connection between the frame and the temples is accomplished by the connectors having the resilient portions, the temples can be rapidly installed, removed, or replaced.

What is claimed is:

1. Eyeglasses capable of being recharged and providing three-stage lighting, wherein the eyeglasses are connected with lighting devices and are characterized in that:
each of two temples of the eyeglasses has a front end whose outer side is connected with a said lighting device, each said lighting device comprising a housing for housing a circuit board and a battery, wherein the circuit board is connected with a switch button and a light-emitting body and is so configured that, by pressing the switch button, the light-emitting body is switched between a constant lighting mode, an intermittent flashing mode, and an OFF mode, thus providing lighting or warning through three-stage control; and
each said temple has a charging hole formed adjacent to the battery of a corresponding said lighting device and configured for charging the battery.

2. The eyeglasses of claim 1, wherein the front end of each said temple is pivotally connected to a connector by a threaded fastener, and each said connector has a resilient portion for engaging with an engaging hole of a frame of the eyeglasses, thus allowing the temples to be rapidly installed, removed, or replaced.
